(19) United States
(12) Patent Application Publication
(10) Pub. No.: US 2025/0340235 A1
(43) Pub. Date: Nov. 6, 2025

(54) System and Method for Facilitating the Autonomous Navigation of a Utility and Delivery Cart

(71) Applicant: Quasi Inc., Frederick, MD (US)

(72) Inventors: Vladimir Lebedev, Ijamsville, MD (US); Fedor Bokov, Rockville, MD (US); Maxim Didenko, Poolesville, MD (US)

(21) Appl. No.: 18/816,563

(22) Filed: Aug. 27, 2024

Related U.S. Application Data
(60) Provisional application No. 63/641,672, filed on May 2, 2024.

(51) Int. Cl. B62B 5/00; G01C 21/16

(52) U.S. Cl. CPC B62B 5/004; B62B 5/0073; G01C 21/1652

(57) ABSTRACT

A system and a method for facilitating the autonomous navigation of a utility and delivery cart implements new means for a motorized cart to operate in different environments under specific operational conditions. The system includes a structural frame, a controller, a plurality of navigational sensors, a portable power source, a pair of caster wheels, and a pair of motorized wheels. The structural frame corresponds to the main structure of the system that can be customized to carry different payloads and accommodate different accessories. The pair of caster wheels and the pair of motorized wheels enable the movement of the structural frame. The controller and the plurality of navigational sensors allow the autonomous operation of the pair of motorized wheels under specific operational configurations. The portable power source provides the power necessary for the operation of the controller, the plurality of navigational sensors, and the pair of motorized wheels.

### FIELD OF THE INVENTION

The present invention relates generally to transportation devices and autonomous systems. More specifically, the present invention discloses novel means to facilitate the safe and efficient autonomous navigation of a utility and delivery cart within an operational environment.

### BACKGROUND OF THE INVENTION

A wide variety of autonomous delivery robots are used in manufacturing, warehouses, datacenters, point of sales, and distribution applications. One major existing problem with autonomous mobile robots is the inflexible, rigid design of most autonomous robots that leads to very big implications:

1. Rigid designs do not allow customization of the robot which prevents adaption to operate outside of a very narrow intended use case. Redesigning such robots for different sizes or payloads is a time consuming and expensive process since the process is keen to designing a whole new robot from scratch. The redesign process would require complete reprogramming of the robot as well as the navigational and operational software stacks.

2. Such mobile robots are expensive to manufacture since the process involves many custom parts for the robotic frame, robotic enclosure, and mounts for all the hardware that enables autonomous operation. Furthermore, many required components for autonomous operations such as environmental mapping and proximity sensors, power supply, control sensors, drive systems, warning systems, and user controls are integral parts of such designs. These components and the associated wiring are built into the overall robot design and the locations are hardcoded in the software that runs the robot.

Another major drawback of existing mobile robot designs is the inadequate sensing system for navigating in crowded and tight spaces. Existing mobile robots usually include few (16 or less) infrared or ultrasonic sensors to measure the distance to obstacles during navigation that are queried by the central processing unit a few times per second. Therefore, there is a need for an improved autonomous system that is customizable by the user, adaptable to different environments, and can better operate under different operational conditions.

### SUMMARY OF THE INVENTION

The present invention discloses a system and a method for facilitating the autonomous navigation of a utility and delivery cart. The present invention features different autonomous modes of operation, automatically avoids obstacles, tracks position in an internal area map, executes complex navigation behaviors, warns when unsafe operating conditions occur, and may be connected to a network. The present invention includes an autonomous navigation system, and a propulsion system integrated into a structural frame constructed from industry standard Aluminum extrusions. The structural frame can be easily modified to any specified dimensions and configurations for specific operational requirements (e.g., width, length, height, number of shelves, etc.). The present invention can be quickly and precisely changed to specific sizes, payloads, and other requirements of the customer. Further, the navigation and propulsion systems can include, but are not limited to, two integrated wheels/hub electric motors, a motor control unit, an internal battery, a battery charging port, a stereo vision camera, a Light Detection and Ranging (LiDAR) unit, an array of ultrasonic sensors, a touchscreen for user interactions, etc.

Further, the structural frame of the present invention utilizes different Aluminum extrusions including, but not limited to, 4040 extrusions for the corner posts of the structural frame, 2040 extrusions for the shelf holders, etc. The use of Aluminum extrusions allow inexpensive sourcing of such materials and allow the implementation of standard assembling methods using the corresponding fasteners. The shelf panels can also be made from Aluminum composite panels (ACP) that are designed to be used with Aluminum extrusions and can also be cut to specific sizes. Further, the overall configuration of the present invention (i.e., width, length, height, number of shelfs, shelf configurations, number of shelfs, etc.) can be stored in a single Extensible Markup Language (XML) file in the integrated controller which can be used to calculate, plan, and execute autonomous navigation maneuvers. Furthermore, the present invention can include a navigation system with completely different Time of Flight (TOF) sensors that features a total of 1024 infrared beams and dedicated microcontrollers to control these sensors at a resolution of 30 times per second. The proposed infrared array requires 1.5 or less the width of the present invention to operate, thus enabling maneuvering in very tight spaces. Additional features and benefits of the present invention are further discussed in the sections below.

### BRIEF DESCRIPTION OF THE DRAWINGS

FIG. 1 is a top-front-left perspective view of the system of the present invention.

FIG. 2 is a top-rear-left perspective view of the system of the present invention.

FIG. 3 is a bottom-front-left perspective view of the system of the present invention.

FIG. 4 is a bottom-rear-left perspective view of the system of the present invention.

FIG. 5 is a right-side view of the system of the present invention.

FIG. 6 is a top-rear-right perspective view of the system of the present invention.

FIG. 7 is a bottom-front-right perspective view of the system of the present invention.

FIG. 8 is a top-rear-right exploded perspective view of the system of the present invention.

FIG. 9 is a top-front-right perspective view of the system of the present invention, wherein several arrangements of the structural frame is shown.

FIG. 10 is a top-rear-right exploded perspective view of the structural frame of the system of the present invention.

FIG. 11 is a magnified view of the connection between a support rail and a shelf of the system of the present invention.

FIG. 12 is a top-front-right perspective view of the electronics housing of the system of the present invention.

FIG. 13 is a top exploded perspective view of a lower Time-of-Flight (TOF) sensor of the system of the present invention.

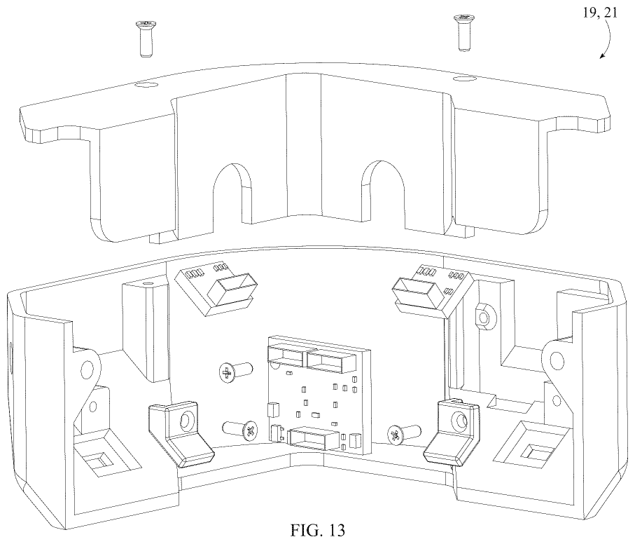

FIG. 14 is a top exploded perspective view of an upper TOF sensor of the system of the present invention.

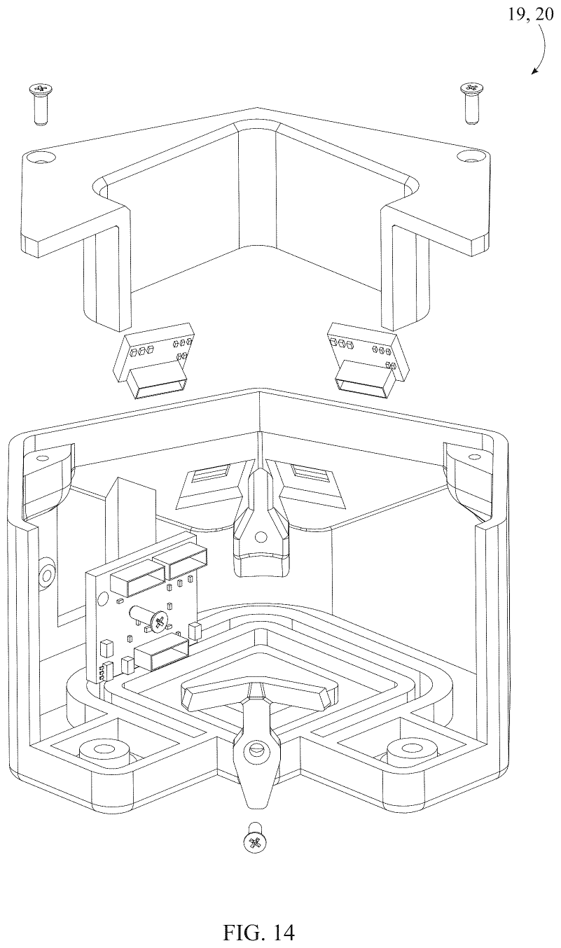

FIG. 15 is a top exploded perspective view of an image capturing device of the system of the present invention.

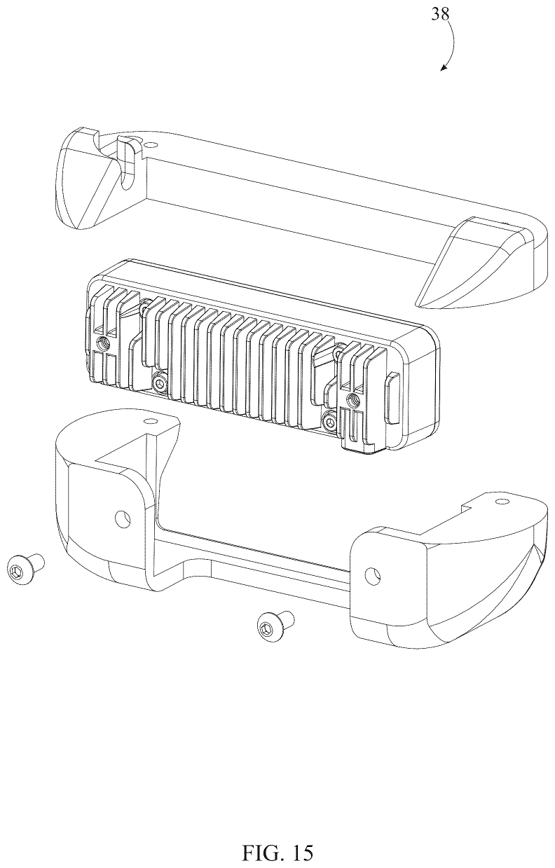

FIG. 16 is a schematic view of the lower TOF sensor coverage of the system of the present invention.

FIG. 17 is a schematic view of the upper TOF sensor coverage of the system of the present invention.

FIG. 18 is a schematic view of the light detection and ranging (LiDAR) sensor coverage of the system of the present invention.

FIG. 19 is a schematic view of the structure of a motorized wheel of the system of the present invention.

FIG. 20 is a schematic view of the electronic connections and the electrical connections of the system of the present invention, wherein the electronic connections are shown in dashed lines, and wherein the electrical connections are shown in solid lines.

FIG. 21 is a schematic view of the software application of the system of the present invention, wherein the waypoints feature of the software application is shown.

FIG. 22 is a schematic view of the software application of the system of the present invention, wherein the area map feature of the software application is shown.

FIG. 23 is a schematic view of the software application of the system of the present invention, wherein the navigation feature of the software application is shown.

FIG. 24 is a schematic view of the software application of the system of the present invention, wherein the settings feature of the software application is shown.

FIG. 25 is a schematic view of the software application of the system of the present invention, wherein a mobile version of the waypoints feature is shown.

### DETAIL DESCRIPTIONS OF THE INVENTION

All illustrations of the drawings are for the purpose of describing selected versions of the present invention and are not intended to limit the scope of the present invention.

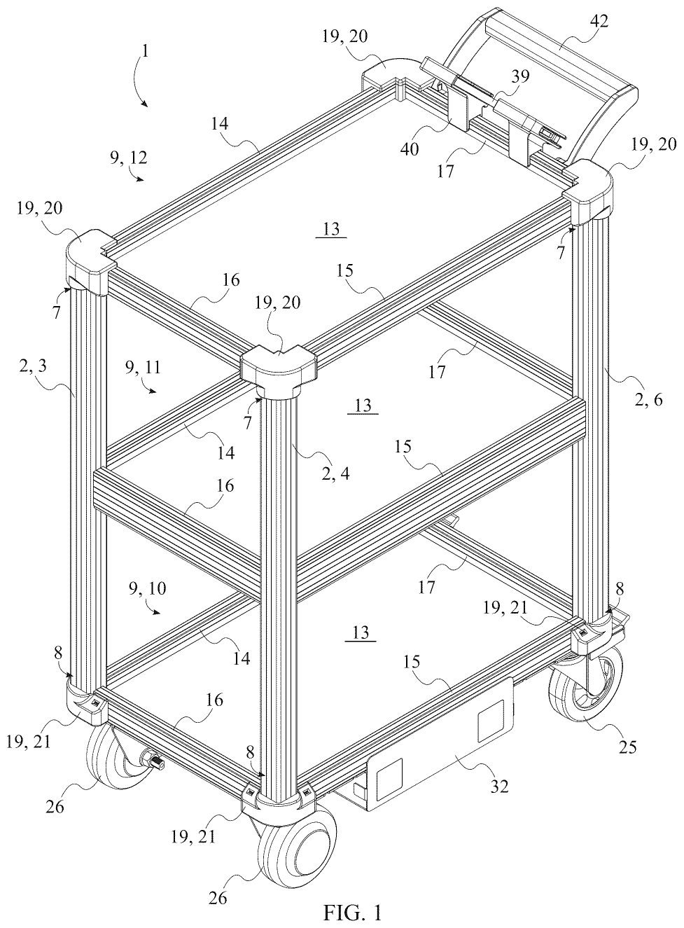

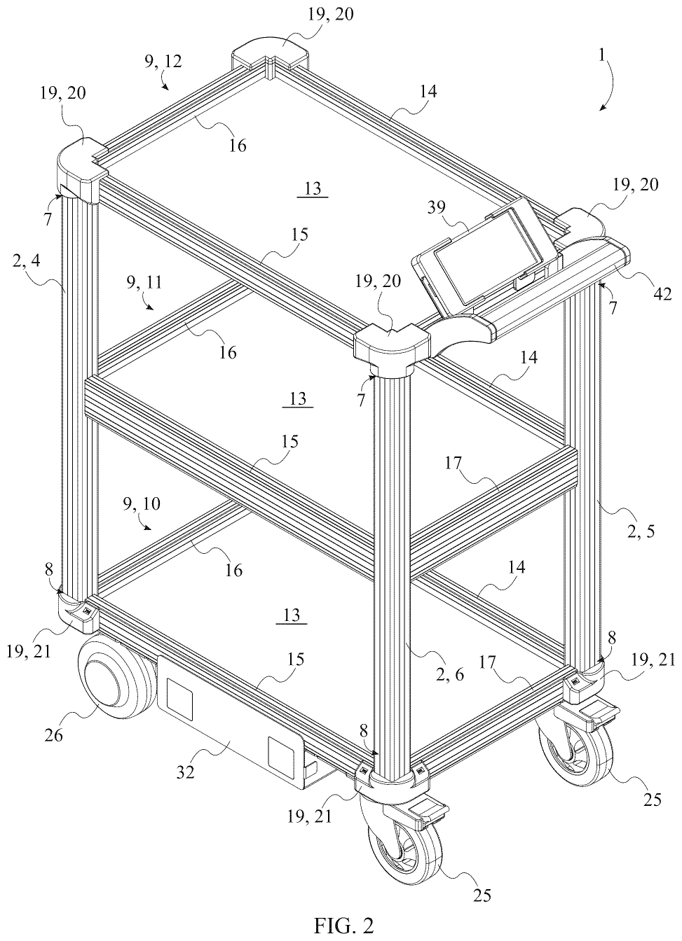

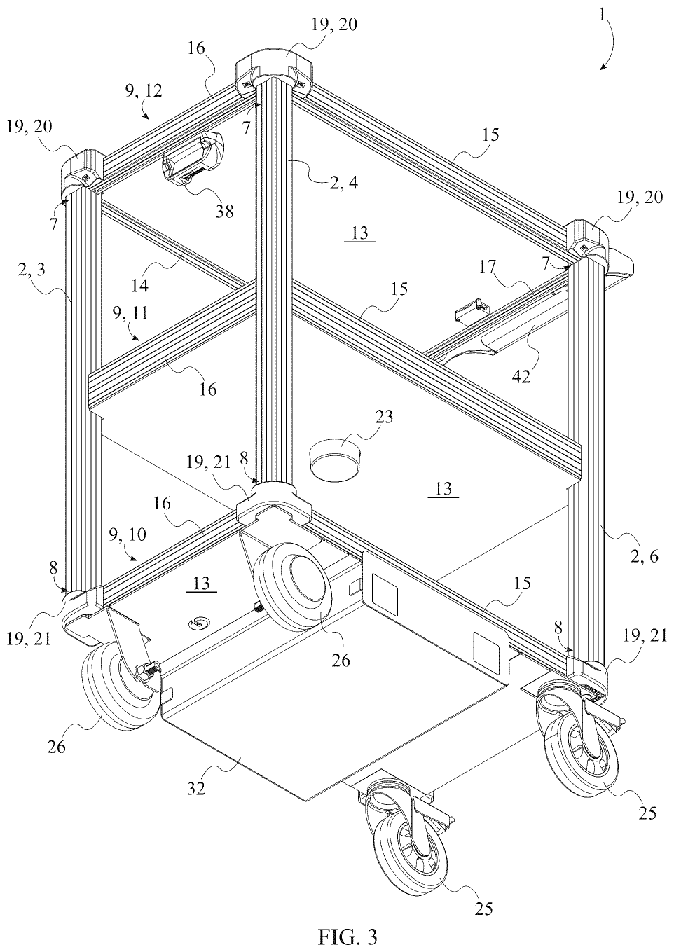

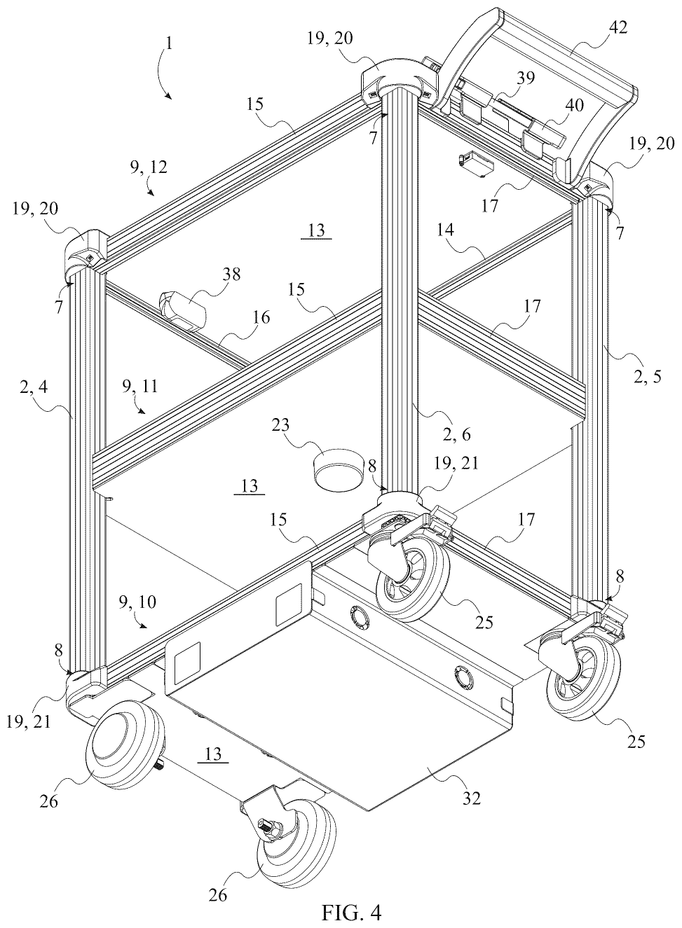

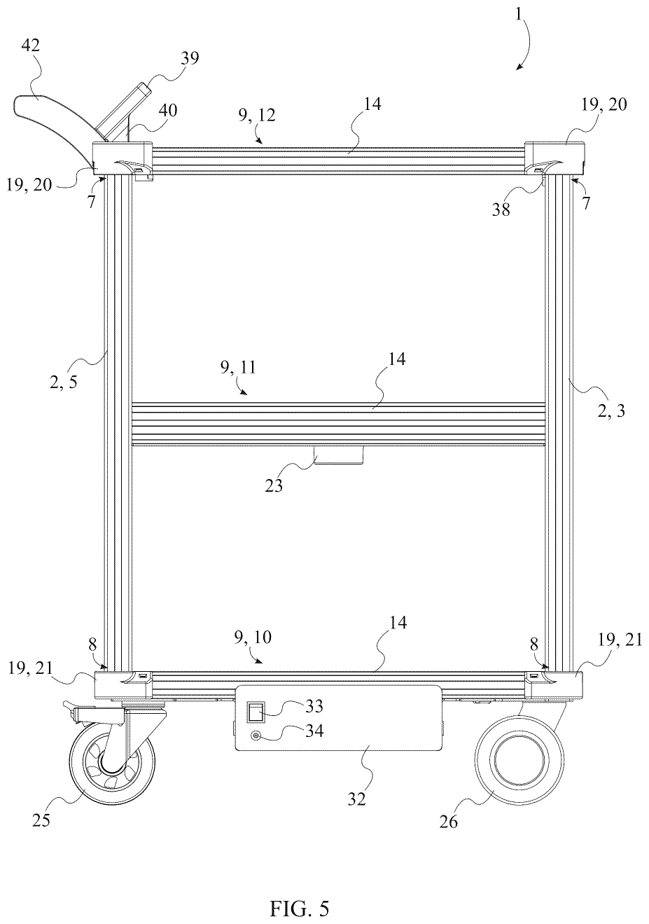

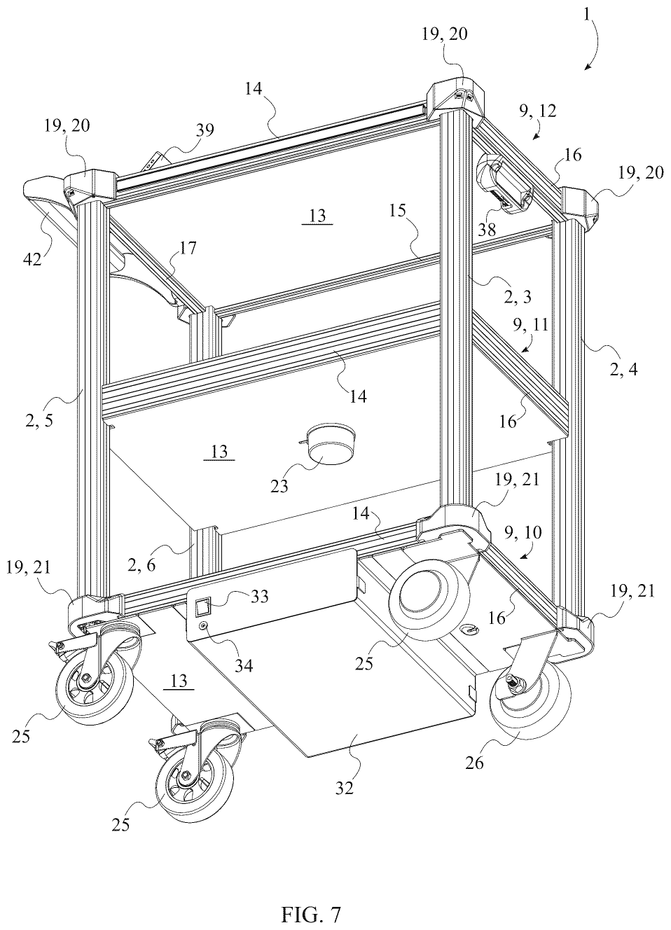

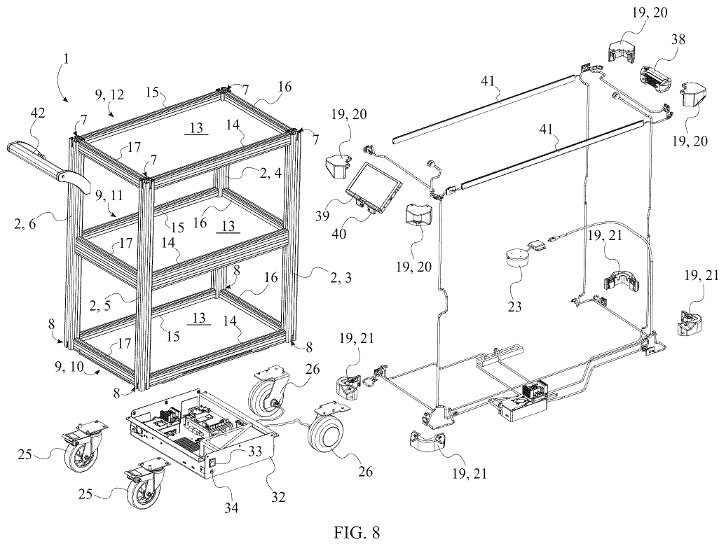

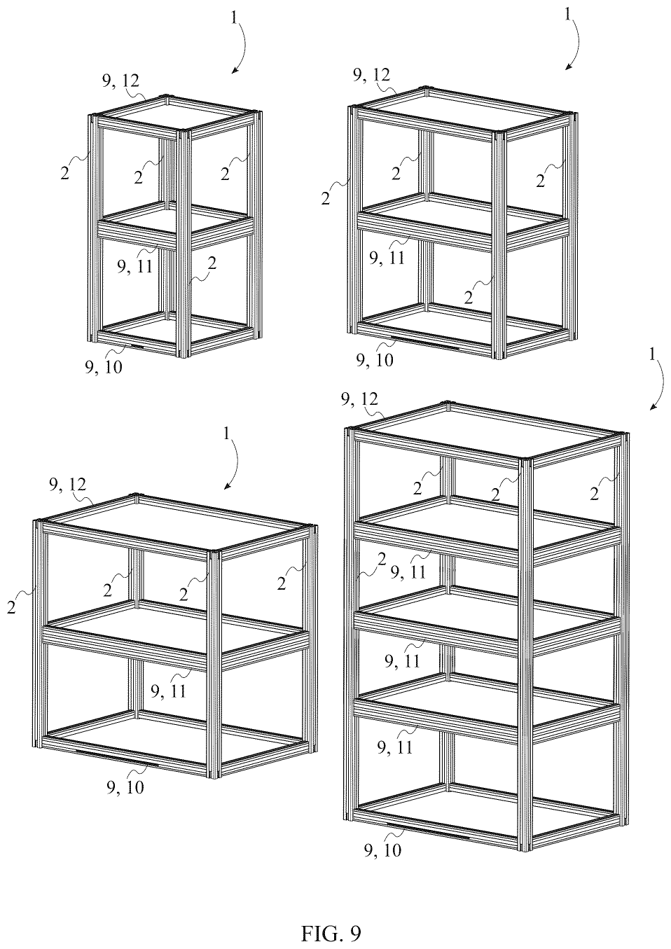

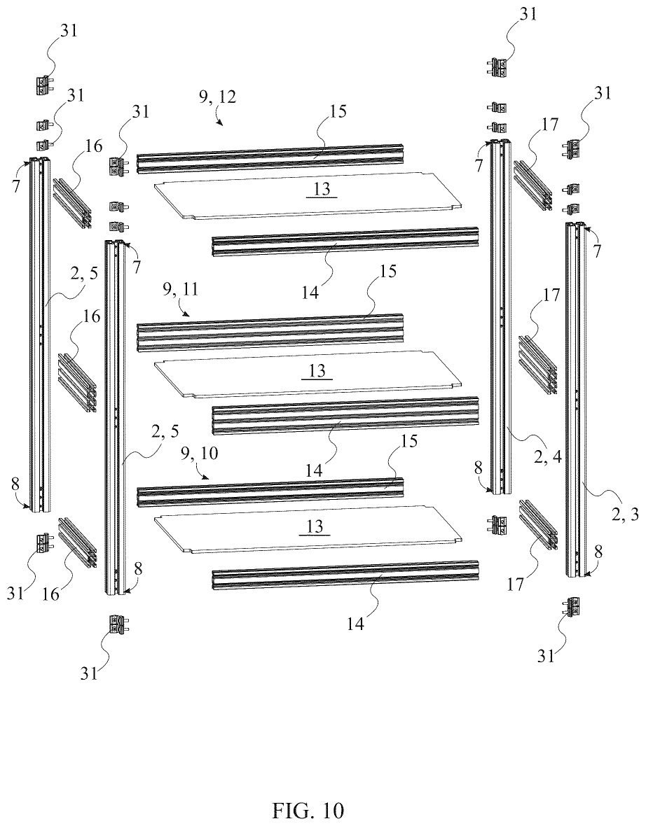

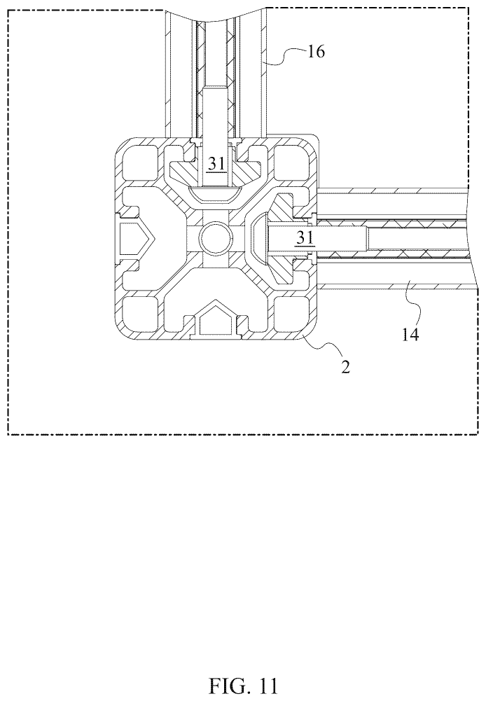

The present invention discloses a system and a method for facilitating the autonomous navigation of a utility and delivery cart. The present invention implements a new system for a motorized cart for utility and delivery applications that can be easily customized to operate in different environments under specific operating conditions. As can be seen in FIG. 1 through 12 and 20, the system of the present invention comprises a structural frame 1, a controller 18, a plurality of navigational sensors 19, a portable power source 24, a pair of caster wheels 25, and a pair of motorized wheels 26. The structural frame 1 corresponds to the main structure of the present invention that can be customized to carry different payloads, accommodate different accessories, and/or freely move through the desired environment. The pair of caster wheels 25 and the pair of motorized wheels 26 enable the movement of the structural frame 1. The controller 18 and the plurality of navigational sensors 19 allow the autonomous operation of the pair of motorized wheels 26 under specific operational configurations of the present invention. The portable power source 24 provides the power necessary for the autonomous operation of the controller 18, the plurality of navigational sensors 19, and the pair of motorized wheels 26.

The general configuration of the aforementioned components allows a motorized cart to transport payloads safely and efficiently in different operational environments. As previously discussed, the structural frame 1 is a customizable structure that can be modified to meet specific operational requirements. As can be seen in FIG. 1 through 12 and 20, the structural frame 1 comprises a plurality of support rails 2 and a plurality of shelves 9. The plurality of support rails 2 includes several rails of equal size and shape that can be arranged to form a vertical structure to support the plurality of shelves 9. For example, the structural frame 1 can be shaped into an overall rectangular structure, with four support rails arranged to serve as the four vertical support columns positioned on each corner of the rectangular structural frame 1. Further, the plurality of shelves 9 corresponds to several shelves that can support the payload to be transported by the present invention as well as other components of the present invention. For example, in the rectangular embodiment of the structural frame 1, the plurality of shelves 9 can include several rectangular shelf structures that are removably connected to the corner support rails of the plurality of support rails 2 to form the overall rectangular structure of the structural frame 1.

As can be seen in FIG. 1 through 12 and 20, the present invention can be arranged as follows: the plurality of shelves 9 is positioned parallel and offset to each other to form a vertical stack of shelves to hold the desired payload in a safe and comfortable manner. The plurality of support rails 2 is positioned parallel to each other to form a vertical support structure that can hold the plurality of shelves 9 in a vertical arrangement with the shelves positioned at a specific distance from each other. Further, the plurality of support rails 2 is perimetrically distributed about each of the plurality of shelves 9 to laterally support the plurality of shelves 9. In addition, each of the plurality of support rails 2 is laterally connected to each of the plurality of shelves 9. In other words, each shelf of the plurality of shelves 9 is laterally supported by each of the plurality of support rails 2 to maintain the plurality of shelves 9 off the ground and separate from each other at the desired distances.

As can be seen in FIG. 1 through 12 and 20, the pair of caster wheels 25 and the pair of motorized wheels 26 are further perimetrically distributed about a base shelf 10 of the plurality of shelves 9 to evenly distribute the pair of caster wheels 25 and the pair of motorized wheels 26 across the base shelf 10. The pair of motorized wheels 26 and the pair of caster wheels 25 are preferably positioned on the surface of the base shelf 10 that is oriented towards the ground. In addition, the pair of motorized wheels 26 is mounted onto the base shelf 10 of the plurality of shelves 9 to secure each motorized wheel to the base shelf 10. Similarly, the pair of caster wheels 25 is also mounted onto the base shelf 10 of the plurality of shelves 9, opposite to the pair of motorized wheels 26, to secure each caster wheel to the base shelf 10. Thus, the structural shelf is supported by the pair of caster wheels 25 and the pair of motorized wheels 26.

As can be seen in FIG. 1 through 12 and 20, the plurality of navigational sensors 19 is further distributed throughout the structural frame 1 to arrange each of the plurality of navigational sensors 19 at strategic locations throughout the structural frame 1 that help monitor different factors that affect the autonomous operation of the present invention. In addition, the pair of motorized wheels 26 and the plurality of navigational sensors 19 are electronically connected to the controller 18. The controller 18 preferably includes an autonomous navigational software that processes the sensors signals from the plurality of navigational sensors 19 and generates appropriate command signals for the pair of motorized wheels 26. This way, the corresponding signals can be transmitted between the pair of motorized wheels 26, the plurality of navigational sensors 19, and the controller 18. For example, sensor signals generated by the plurality of navigational sensors 19 related to a potential obstacle can be relayed to the controller 18 for processing. After which, the corresponding command signals can be generated by the controller 18 and transmitted to the pair of motorized wheels 26 to adjust the operation of the pair of motorized wheels 26 to avoid the obstacle. Furthermore, the pair of motorized wheels 26, the plurality of navigational sensors 19, and the controller 18 are electrically connected to the portable power source 24 to receive the power necessary for the autonomous operation of each electrical and electronic component. In other embodiments, the present invention can be rearranged to accommodate specific payloads or to operate in special environments.

As previously discussed, the structural frame 1 is designed as a modular structure that can be modified to meet specific operational requirements. As can be seen in FIG. 1 through 12 and 20, in the rectangular embodiment of the structural frame 1, the plurality of support rails 2 comprises a first front rail 3, a second front rail 4, a first rear rail 5, and a second rear rail 6 corresponding to the corner support rails of the rectangular structural frame 1. In addition, the plurality of shelves 9 each comprises a shelf panel 13 that corresponds to the flat surface of each shelf of the plurality of shelves 9. To form the rectangular design of the structural frame 1, the first front rail 3, the second front rail 4, the first rear rail 5, and the second rear rail 6 are positioned parallel to each other. In addition, the first front rail 3, the second front rail 4, the first rear rail 5, and the second rear rail 6 are oriented perpendicular to the shelf panel 13 of each of the plurality of shelves 9. This way, a straight rectangular structural frame 1 is formed that keeps the plurality of shelves 9 parallel to the ground to prevent the payload from falling off the plurality of shelves 9.

As can be seen in FIG. 1 through 12 and 20, to position the plurality of support rails 2 on the corners of each of the plurality of shelves 9, the first front rail 3 is further positioned opposite to the second front rail 4 across each shelf panel 13 of the plurality of shelves 9. Similarly, the first rear rail 5 is positioned opposite to the second rear rail 6 across each shelf panel 13 of the plurality of shelves 9. This way, the front rails and the rear rails are positioned opposite each other across the shelf panel 13, respectively. Furthermore, the first front rail 3 is positioned opposite to the first rear rail 5 across each shelf panel 13 of the plurality of shelves 9. Similarly, the second front rail 4 is positioned opposite to the second rear rail 6 across each shelf panel 13 of the plurality of shelves 9. Thus, each support rail is positioned on a corner of the rectangular frame, with each shelf of the plurality of shelves 9 being laterally supported by the plurality of support rails 2. In alternate embodiments, different non-rectangular designs may be implemented which may require additional support rails, and/or the plurality of shelves 9 may be rearranged to accommodate different payloads.

As can be seen in FIG. 1 through 12, the structural frame 1 is specially designed to facilitate the reconfiguration of the plurality of support rails 2 or the plurality of shelves 9 according to the operational requirements of the present invention. To facilitate the reconfiguration of the structural frame 1, the present invention may further comprise a plurality of rail connectors 31 that allow for the detachable connection between the different components of the structural frame 1. In addition, the plurality of shelves 9 may each further comprising a first lengthwise rail 14, a second lengthwise rail 15, a first widthwise rail 16, and a second widthwise rail 17. The first lengthwise rail 14, the second widthwise rail 17, the second widthwise rail 17, and the second widthwise rail 17 form a rectangular frame around the shelf panel 13 that facilitate the connection of the shelf panel 13 to the plurality of support rails 2 using the plurality of rail connectors 31. The plurality of rail connectors 31 includes several connectors designed to interlock the plurality of shelves 9 at different locations along the plurality of support rails 2 without the use of fasteners.

As can be seen in FIG. 1 through 12, the structural frame 1 can be assembled using the plurality of rail connectors 31 in following manner: the first widthwise rail 16 is terminally connected in between the first front rail 3 and the second front rail 4 by a pair of rail connectors of the plurality of rail connectors 31. This way, the first widthwise rail 16 laterally secures each shelf panel 13 to the two front rails of the structural frame 1. Similarly, the second widthwise rail 17 is terminally connected in between the first rear rail 5 and the second rear rail 6 by a pair of rail connectors of the plurality of rail connectors 31 so that the second widthwise rail 17 laterally secures each shelf panel 13 to the two rear rails of the structural frame 1. Further, the first lengthwise rail 14 is terminally connected in between the first front rail 3 and the first rear rail 5 by a pair of rail connectors of the plurality of rail connectors 31. This way, each shelf panel 13 is laterally secured to first front rail 3 and the first rear rail 5 by the first lengthwise rail 14. Similarly, the second lengthwise rail 15 is terminally connected in between the second front rail 4 and the second rear rail 6 by a pair of rail connectors of the plurality of rail connectors 31, which laterally secures each shelf panel 13 to the second front rail 4 and the second rear rail 6. Thus, each shelf panel 13 is securely connected to the plurality of support rails 2. In alternate embodiments, the lateral rails that frame each shelf panel 13 can be altered to accommodate different designs of the structural frame 1. In other embodiments, different accessories can be removably attached to any rail of the structural frame 1 including, but not limited to, transparent or opaque doors with automatic door locks for protection of the payload.

As can be seen in FIG. 1 through 12, the structural frame 1 is designed to be customized by facilitating the detachment and attachment of the different components using connectors that do not require fasteners or other tools for fastening. In the preferred embodiment, the first front rail 3, the second front rail 4, the first rear rail 5, the second rear rail 6, the first lengthwise rail 14, the second lengthwise rail 15, the first widthwise rail 16, and the second widthwise rail 17 are slotted metal extrusions such as Aluminum slotted extrusions. In addition, the plurality of rail connectors 31 is a plurality of slot connectors matching the cross-sectional shape and size of the slotted metal extrusions. Different sizes of slotted metal extrusions can be utilized for each rail. For example, the first front rail 3, the second front rail 4, the first rear rail 5, and the second rear rail 6 can be 4040 Aluminum extrusions. The first lengthwise rail 14, the second lengthwise rail 15, the first widthwise rail 16, and the second widthwise rail 17 of the base shelf 10 and an upper shelf 12 of the plurality of shelves 9 can be 2040 Aluminum extrusions. On the other hand, the first lengthwise rail 14, the second lengthwise rail 15, the first widthwise rail 16, and the second widthwise rail 17 of at least one intermediate shelf 11 of the plurality of shelves 9 can be 2060 Aluminum extrusions. Further, the plurality of rail connectors 31 can be several slot sliding nuts that can be fixed to the corresponding ends of the first lengthwise rail 14, the second lengthwise rail 15, the first widthwise rail 16, and the second widthwise rail 17 of each shelf. The design of the plurality of rail connectors 31 matches the shape of the slots of the slotted metal extrusions. For example, for T-slot metal extrusions, T-slot sliding nuts can be utilized. Alternatively, for V-slot metal extrusions, V-slot sliding nuts can be utilized. In other embodiments, different interlocking rails and the corresponding connectors can be implemented for the different components of the structural frame 1.

The pair of motorized wheels 26 and the pair of caster wheels 25 are arranged so that the present invention is driven from the front. As can be seen in FIG. 1 through 12, the pair of motorized wheels 26 is positioned adjacent to the first widthwise rail 16 of the base shelf 10 of the plurality of shelves 9. This way, the front of the structural frame 1 is preferably the side of the structural frame 1 where the first front rail 3 and the second front rail 4 are positioned. Further, the pair of caster wheels 25 is positioned adjacent to the second widthwise rail 17 of the base shelf 10 of the plurality of shelves 9 so that the rear of the structural frame 1 corresponds to the side of the structural frame 1 where the first rear rail 5 and the second rear rail 6 are positioned. Thus, the present invention can move by engaging the pair of motorized wheels 26, and the pair of caster wheels 25 follow the direction of the pair of motorized wheels 26. If the present invention takes a turn, a motorized wheel of the pair of motorized wheels 26 accelerates and/or the other motorized wheel decelerates, depending on the speed at which the present invention can safely make the turn. In alternate embodiments, different arrangements of motorized wheels and caster wheels can be implemented, or all wheels can be implemented as motorized wheels.

As can be seen in FIG. 1 through 12, the pair of motorized wheels 26 and the pair of caster wheels 25 are preferably arranged to evenly support the load from the structural frame 1 and the payload being carried by the present invention. To do so, the plurality of support rails 2 may each comprise a first rail end 7 and a second rail end 8 corresponding to the terminal ends of each support rail. The first rail end 7 is positioned opposite to the second rail end 8 along the corresponding support rail of the plurality of support rails 2 due to the elongated design of each support rail. Further, the base shelf 10 of the plurality of shelves 9 is positioned adjacent to each second rail end 8 of the plurality of support rails 2. In other words, each second rail end 8 of the plurality of support rails 2 is positioned adjacent to the ground. Furthermore, the pair of motorized wheels 26 and the pair of caster wheels 25 are positioned opposite to each first rail end 7 of the plurality of support rails 2 across the base shelf 10 of the plurality of shelves 9. This way, the pair of caster wheels 25 and the pair of motorized wheels 26 are positioned against the ground to support the structural frame 1 and the payload.

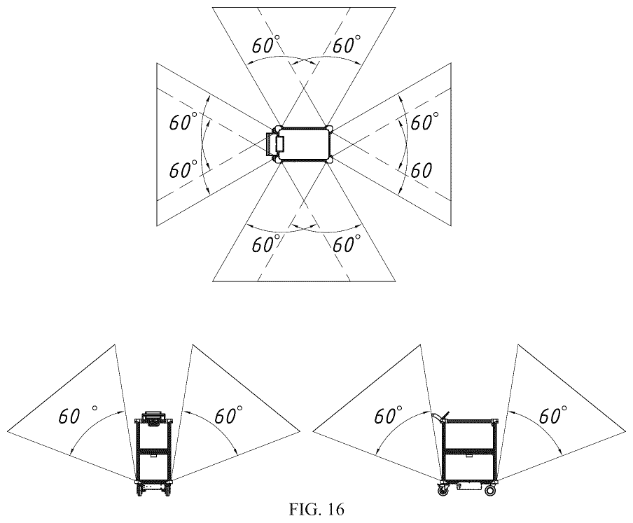

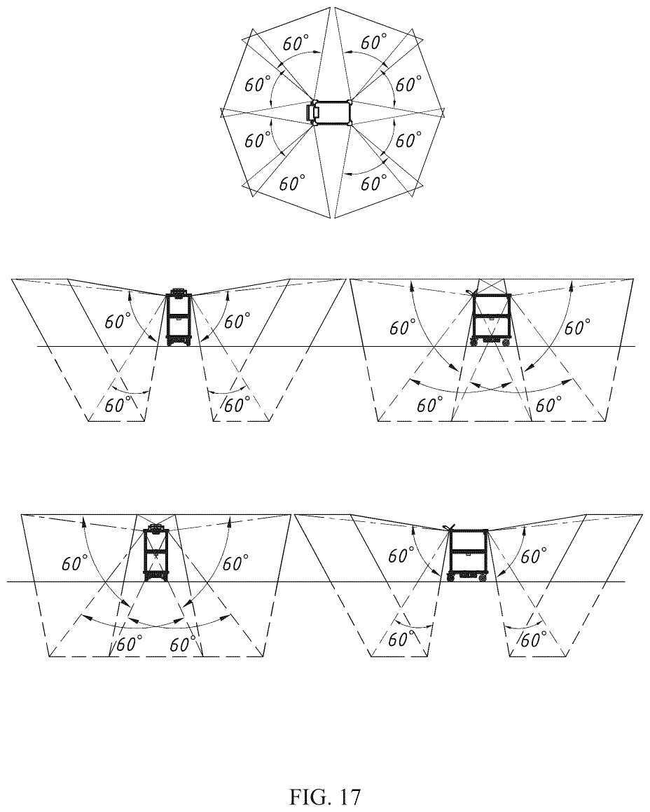

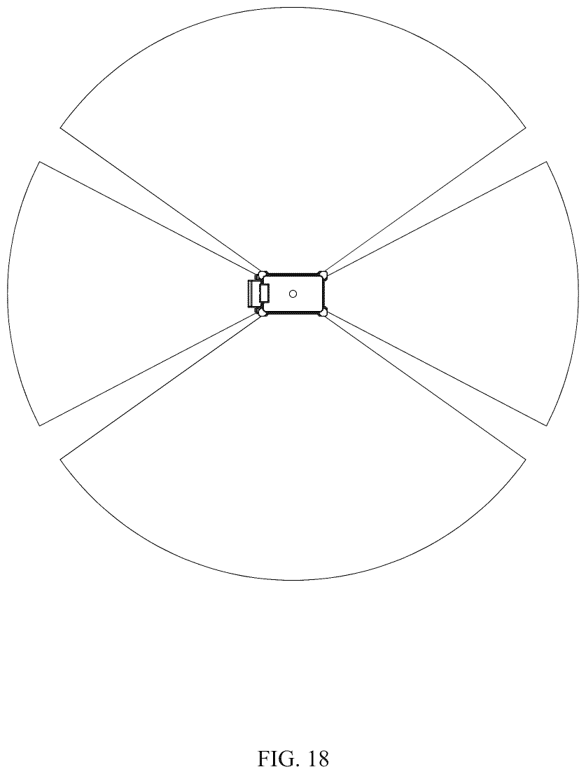

As previously discussed, the plurality of navigational sensors 19 enables the present invention to monitor different factors surrounding the structural frame 1 that can affect the autonomous operation of the present invention. As can be seen in FIG. 1 through 12 and 16 through 20, the plurality of navigational sensors 19 may comprise a plurality of upper time-of-flight (TOF) sensors 20 and a plurality of lower TOF sensors 21 that enable the determination of the distances between the structural frame 1 and the surrounding objects in the operational environment. The plurality of upper TOF sensors 20 and the plurality of lower TOF sensors 21 are preferably TOF infrared sensor arrays that enable the automatic precise measurement of distances between the structural frame 1 and surrounding objects to avoid collisions during navigation. Each of the plurality of upper TOF sensors 20 is mounted onto a corresponding first rail end 7 of the plurality of support rails 2 to position the upper TOF sensors on the top area of the structural frame 1. On the other hand, each of the plurality of lower TOF sensors 21 is mounted onto a corresponding second rail end 8 of the plurality of support rails 2 to position the lower TOF sensors on the base of the structural frame 1.

As can be seen in FIG. 1 through 12 and 16 through 20, each TOF sensor can be preferably implemented as follows: each TOF sensor is provided within a housing that protects the corresponding TOF infrared sensor arrays, with eight total housings located on each of the eight corners of the structural frame 1. Each housing encloses two TOF infrared sensor arrays, and each array creates an 8×8 grid with 64 independent infrared beams. As a result, 128 beams are implemented in each corner of the structural frame 1. Further, a dedicated custom-made microcontroller 18 can be provided in each housing of the TOF sensors. The arrangement of the upper TOF sensors covers the entire perimeter of the structural frame 1 and allow reaching “above” the height of the structural frame 1 to navigate under desks or areas with low clearance. The arrangement of the lower TOF sensors cover “below” the structural frame 1 to detect stairs and low-ground obstacles. In alternate embodiments, different arrangements for the TOF sensors can be implemented to cover different areas surrounding the structural frame 1.

As can be seen in FIG. 1 through 12 and 20, to protect the different electronic and electrical components of the system of the present invention, the present invention may further comprise an electronics housing 32. The electronics housing 32 is designed to support the different electronic and electrical components while allowing access to each component for maintenance and repair. So, the controller 18 and the portable power source 24 are mounted within the electronics housing 32 so that the controller 18 and the portable power source 24 are secured within the electronics housing 32. Further, the electronics housing 32 is mounted onto the base shelf 10 of the plurality of shelves 9 to leave space on the other shelves above the base shelf 10 to retain the desired payload. The electronics housing 32 can include different panels that facilitate the operation of the different components mounted within. For example, the lateral panels can be solid metal panels to support and protect the internal components. Intermediate or sectional panels can be solid plastic panels that allow the unobstructed transmission of wireless signals. In different embodiments, different features can be implemented into the electronics housing 32 to facilitate the operation of different components.

As can be seen in FIG. 1 through 12 and 20, the electronics housing 32 can accommodate features that allow for the power control of the system of the present invention. In some embodiments, the present invention may further comprise a power switch 33, a charging port 34, and at least one data port 35. The power switch 33 corresponds to the main switch that turns the system on or off. The charging port 34 allows the recharging of the portable power source 24. The at least one data port 35 enable the wired connection of the controller 18 to an external computing device. So, the power switch 33, the charging port 34, and the data port are distributed about the electronics housing 32 to not clutter the electronics housing 32. In addition, the power switch 33, the charging port 34, and the data port are integrated into the electronics housing 32 so that each is accessible to the electronics housing 32 without removing the electronics housing 32. Further, the power switch 33 and the data port are electronically connected to the controller 18 to enable the transmission of electronic signals between the components. Furthermore, the power switch 33 and the charging port 34 are electrically connected to the portable power source 24. Thus, the user can turn on/off the system of the present invention via the power switch 33, and the portable power source 24 can be charged via the charging port 34.

As can be seen in FIG. 1 through 12 and 20, to further facilitate the autonomous navigation of the system of the present invention, the present invention may further comprise an Inertial measurement unit (IMU) 36. The IMU 36 facilitates the detection of rotations, accelerations, orientations, and slopes of the structural frame 1. In addition, the plurality of navigational sensors 19 may further comprise at least one environmental sensor 22 that enable the measurement of air quality, humidity, temperature, pressure of the operational environment of the system of the present invention. So, the IMU 36 and the at least one environmental sensor 22 are mounted within the electronics housing 32 to protect the IMU 36 and the at least one environmental sensor 22 with the electronics housing 32. Further, the IMU 36 and the at least one environmental sensor 22 are electronically connected to the controller 18 to enable the relay of the generated signals to the controller 18 for processing. Furthermore, the IMU 36 and the at least one environmental sensor 22 are electrically connected to the portable power source 24 to provide the power necessary for the operation of the IMU 36 and the at least one environmental sensor 22. In other embodiments, additional electronic components and electrical components can be implemented within the electronics housing 32 to facilitate the autonomous operation of the system of the present invention. For example, the system of the present invention may further include, but is not limited to, a hub motors control box, Solid State Relays (SSRs), at least one terminal block, a voltage regulator, cooling fans, etc.

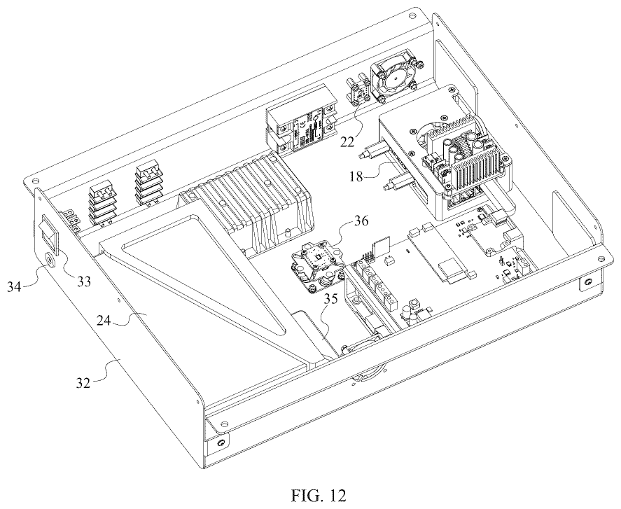

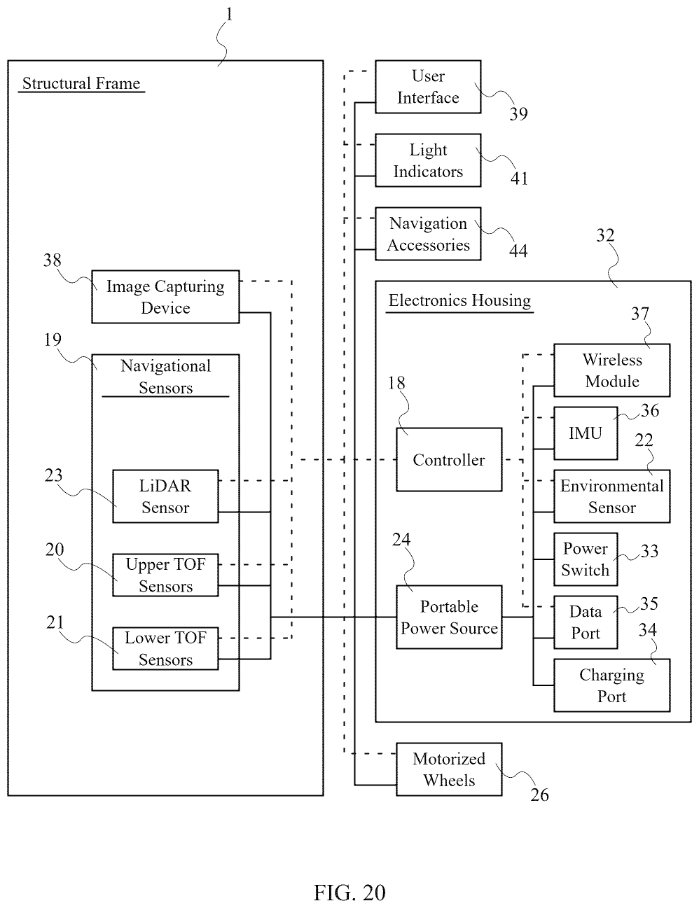

As previously discussed, the present invention can enable the wireless transmission of data to enable remote control and configuration of the system of the present invention. As can be seen in FIGS. 12 and 20, the present invention may further comprise a wireless module 37 that enables the wireless transmission of data via different wireless technologies and protocols. For example, the wireless module 37 can include Wi-Fi antennas that enable the transmission of data via a Wi-Fi network. So, the wireless module 37 is mounted within the electronics housing 32 so that the wireless module 37 is protected by the electronics housing 32. Further, the wireless module 37 is electronically connected to the controller 18 to enable the transmission of data between the wireless module 37 and the controller 18. Furthermore, the wireless module 37 is electrically connected to the portable power source 24 to provide the power necessary for the operation of the wireless module 37. In other embodiments, different wireless technologies can be implemented into the system of the present invention.

As can be seen in FIG. 1 through 12 and 20, the plurality of navigational sensors 19 may further comprise a light detection and ranging (LiDAR) sensor 23 that can be used for remote sensing of the operational environment via pulsed laser beams to measure ranges. The LiDAR sensor 23 is mounted onto an intermediate shelf 11 of the plurality of shelves 9 to secure the LiDAR sensor 23 to the structural frame 1. The positioning of the LiDAR frame allows unobstructed 360-degree view for the laser beam around the structural frame 1 and protects the LiDAR sensor 23 from dust and other particles. In other embodiments, different arrangements of the LiDAR sensor 23 can be implemented for different coverage.

In addition to the plurality of navigational sensors 19, different monitoring devices can be implemented for greater monitoring of the operational environment of the system of the present invention. As can be seen in FIG. 1 through 12, 15, and 20, the present invention may further comprise an image capturing device 38. The image capturing device 38 can be a stereo vision camera that compliments the system's autonomous navigational capabilities by capturing the different elements of the operational environment. So, the image capturing device 38 is perimetrically positioned about an upper shelf 12 of the plurality of shelves 9 to provide unobstructed view of the image capturing device 38. The image capturing device 38 is also mounted onto the upper shelf 12 of the plurality of shelves 9 to provide a wide field of view. Further, the image capturing device 38 is electronically connected to the controller 18 to relay the image data captured by the image capturing device 38. Furthermore, the image capturing device 38 is electrically connected to the portable power source 24 to provide the power necessary for the operation of the image capturing device 38. In some embodiments, the image capturing device 38 can be protected by a camera case and a camera cover that protect the different components of the image capturing device 38. In alternate embodiments, different media devices can be implemented for the autonomous operation of the present invention.

In some embodiments, the system of the present invention can provide means for the user to directly monitor and control the autonomous operation of the present invention. As can be seen in FIG. 1 through 12, the present invention may further comprise a user interface 39 and an interface holder 40. The user interface 39 is preferably a touchscreen display that allows the user to access the autonomous navigation software of the system of the present invention for direct configuration. The interface holder 40 can be custom brackets that hold the user interface 39 at a specific orientation for ease of access by the user. So, the interface holder 40 is perimetrically positioned about an upper shelf 12 of the plurality of shelves 9 to keep the user interface 39 at a comfortable height on the structural frame 1. In addition, the user interface 39 is laterally mounted onto the upper shelf 12 of the plurality of shelves 9 by the interface holder 40 to secure the user interface 39 to the structural frame 1. Further, the user interface 39 is electronically connected to the controller 18 to enable the transmission of data between the controller 18 and the user interface 39. Furthermore, the user interface 39 is electrically connected to the portable power source 24 to provide the power necessary for the operation of the user interface 39.

As previously discussed, the user interface 39 allows the user to directly control and configure the autonomous operation of the system of the present invention. For example, the user interface 39 allows the user to instruct the system of the present invention to autonomously move to a specific destination (waypoint). The user interface 39 can display a graphical list of available waypoints showing the place holders for unused waypoints. The user can manually move the system of the present invention to a desired location and press the place holder function to designate the location to a desired waypoint. The user can label the waypoint with any name for ease of navigation. As the system of the present invention moves in the operational environment, an inner virtual map is automatically constructed by the autonomous navigation software based on data from the IMU 36, the LiDAR sensor 23, the image capturing device 38, and the TOF sensors. Different navigational data can be displayed during the autonomous navigation of the system of the present invention. For example, movement speed is shown on the left of the user interface 39 and a digital compass on the right. In the center of the user interface 39, an emergency stop function can be provided.

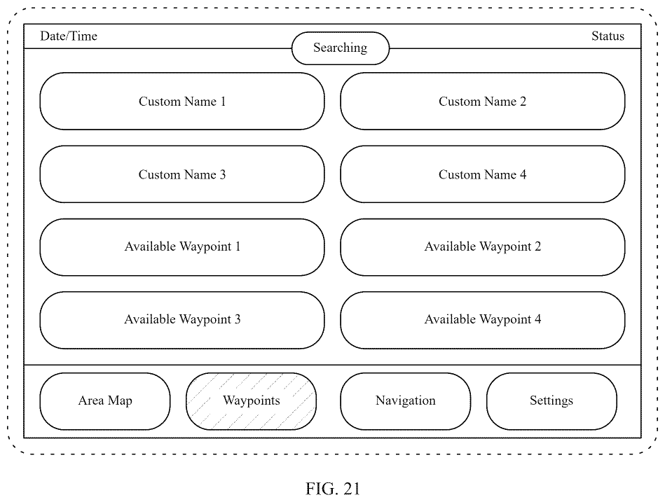

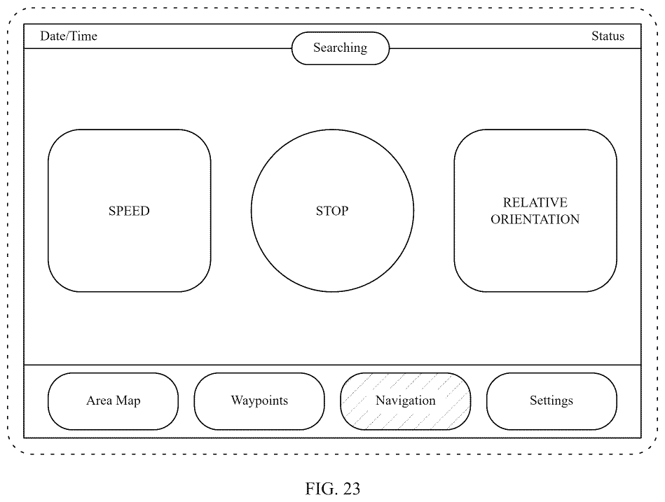

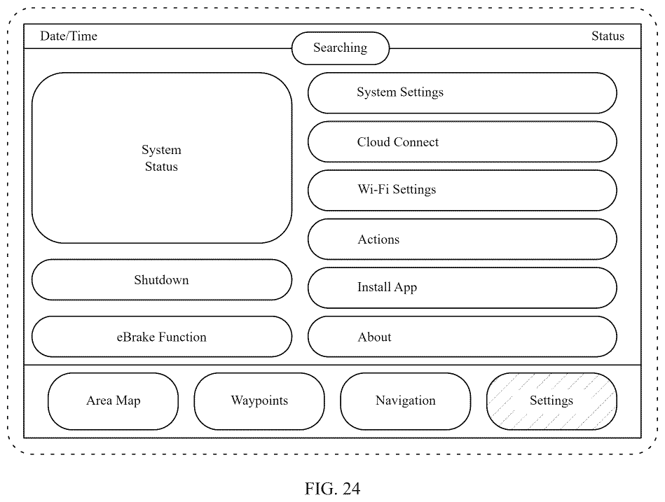

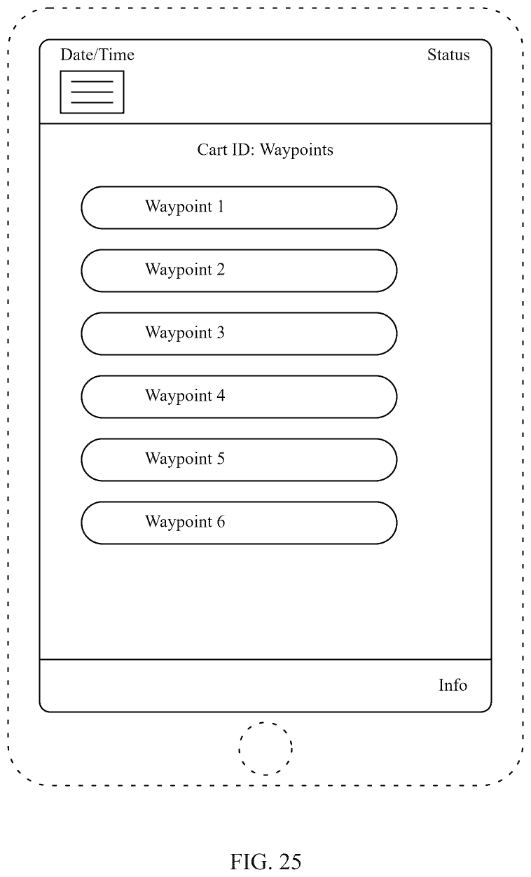

Additional features can be provided on the user interface 39. For example, a display mode can be implemented when power saving mode is enabled. The system of the present invention automatically enters the power saving mode after a predetermined period of inactivity (e.g., one minute by default). When the user interface 39 is engaged or the system of the present invention is moved by the user, the autonomous navigation software automatically re-enters the operational mode. Furthermore, the same operational features displayed on the user interface 39 can be accessed from an external computing device. As can be seen in FIG. 21 through 25, the system of the present invention can further include a software application that can be developed for different computing devices. For example, a mobile application (app) can be developed for smartphones or tablet computers. Similarly, a desktop application can be developed for laptops, desktop computers, etc. In alternate embodiments, different control features can be implemented for different software applications.

In some embodiments, different visual indicators can be implemented into the system of the present invention to visually show the current operational mode of the system. As can be seen in FIG. 1 through 12 and 20, the present invention may further comprise a plurality of light indicators 41 that visually indicate the current mode of operation of the present invention. For example, the plurality of light indicators 41 can be Light Emitting Diode (LED) lights that output a green light when the present invention has reached the designated waypoint, a yellow light when autonomous navigation is in progress, and a red light if there is a navigational error. Combination of colors can also be implemented to indicate other modes of operation. For example, simultaneous output of red and yellow lights can occur when there was an unexpected obstacle during navigation and the system of the present invention is automatically re-routing to avoid that obstacle. So, the plurality of light indicators 41 is perimetrically distributed about an upper shelf 12 of the plurality of shelves 9 so that the plurality of light indicators 41 is clearly visible on the surroundings. The plurality of light indicators 41 is laterally mounted onto the upper shelf 12 of the plurality of shelves 9 to secure the plurality of light indicators 41 to the structural frame 1. Further, the plurality of light indicators 41 is electronically connected to the controller 18 to enable the control of the operation of the plurality of light indicators 41 by the controller 18. Furthermore, the plurality of light indicators 41 is electrically connected to the portable power source 24 to provide the power necessary for the operation of the plurality of light indicators 41. In other embodiments, different visual indicators can be implemented.

As previously discussed, the present invention may be manually moved by the user if necessary. As can be seen in FIG. 1 through 12, to facilitate the manual control of the movement of the present invention, the present invention may further comprise at least one handlebar 42. The at least one handlebar 42 provides a secure structure from which the user can push or pull the structural frame 1. So, the at least one handlebar 42 is perimetrically positioned about an upper shelf 12 of the plurality of shelves 9. This way, the at least one handlebar 42 is a comfortable height from which the user can maneuver the structural frame 1. In addition, the at least one handlebar 42 is laterally mounted onto the upper shelf 12 of the plurality of shelves 9 to secure the at least one handlebar 42 to the structural frame 1. In other embodiments, different mechanisms can be implemented that allow the user to manually move the present invention.

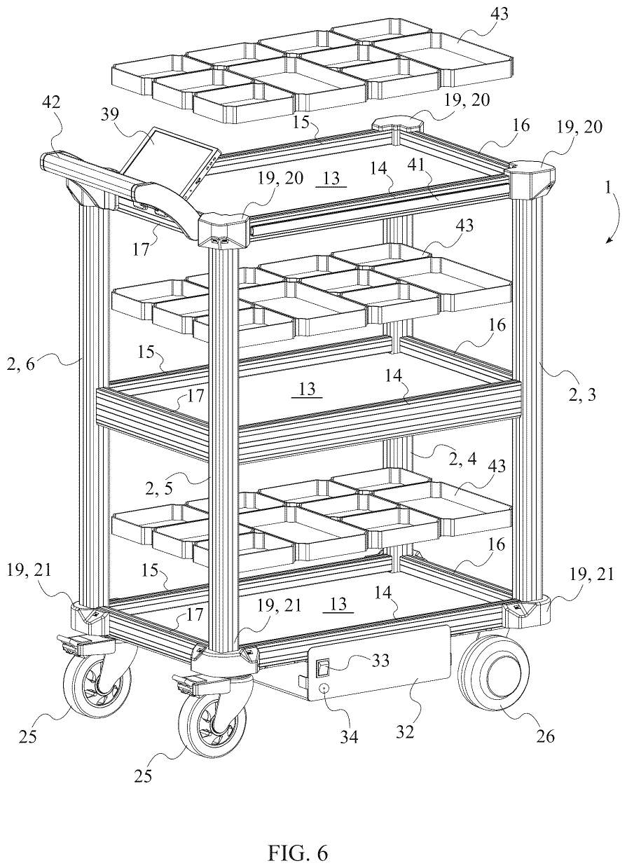

In some embodiments, the present invention can include means to retain different payload items on the plurality of shelves 9. As can be seen in FIG. 6, the present invention may further comprise a plurality of utility trays 43 that can hold specific items that need to be transported throughout the operational environment. Each utility tray of the plurality of utility trays 43 can be situated upon a corresponding shelf of the plurality of shelves 9 so that the payload items can be held on the different shelves on the structural frame 1. In other embodiments, different accessories can be provided to help secure the payload items to different locations on the structural frame 1.

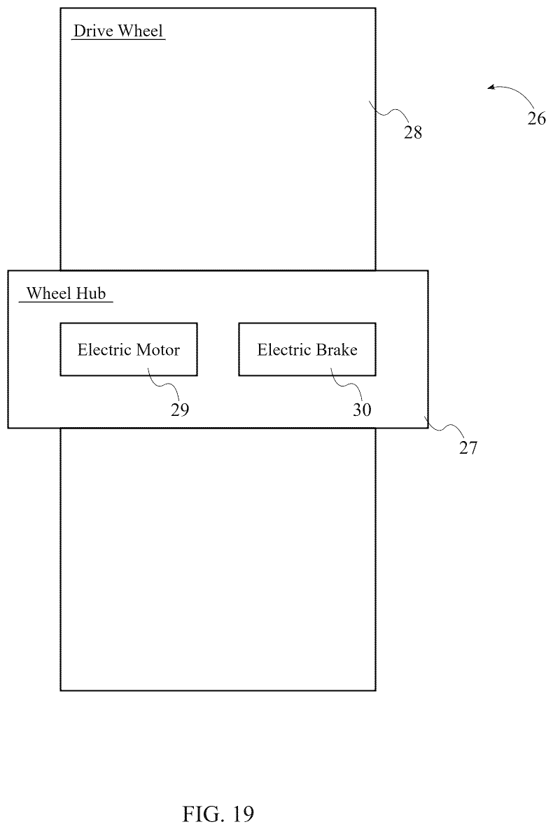

As previously discussed, the pair of motorized wheels 26 provide the propulsion necessary for the autonomous navigation of the present invention. As can be seen in FIGS. 19 and 20, the pair of motorized wheels 26 may each comprise a wheel hub 27, a drive wheel 28, an electric motor 29, and an electric brake 30. The wheel hub 27 corresponds to the structure that allows the rotation of the corresponding drive wheel 28 while securing the corresponding motorized wheel to the structural frame 1. The electric motor 29 generates the torque necessary to rotate the corresponding drive wheel 28 at the desired rotational speed. The electric brake 30 generates the frictional force necessary to decelerate the rotating drive wheel 28. So, the wheel hub 27 is mounted onto the base shelf 10 of the plurality of shelves 9 to secure the corresponding motorized wheel to the structural frame 1. The drive wheel 28 is also rotatably connected to the wheel hub 27 to secure the drive wheel 28 to the wheel hub 27 while enabling the drive wheel 28 to rotate on the wheel hub 27. Further, the electric motor 29 and the electric brake 30 are mounted within the wheel hub 27 to connect the electric motor 29 and the electric brake 30 to the drive wheel 28. In addition, the electric motor 29 and the electric brake 30 are operatively connected to the drive wheel 28. The electric motor 29 is used to accelerate the rotation of the drive wheel 28 by converting electrical energy into mechanical energy. For example, the electric motor 29 can include an electromagnetic stator and a magnetic rotor that allow rotation of the drive wheel 28 in the desired angular direction. On the other hand, the electric brake 30 is used to decelerate the rotation of the drive wheel 28 in a safe and controlled manner. In other embodiments, the pair of motorized wheels 26 can be altered to operate in specific environments.

In some embodiments, the present invention may further comprise a plurality of navigation accessories 44 that can be selectively attached to the structural frame 1 to enhance the autonomous navigation of the system of the present invention. For example, the plurality of navigation accessories 44 can include, but is not limited to, a Radio Frequency Identification (RFID) reader and antennas for scanning inventory, ultraviolet (UV) lamps for area disinfection, camera arrays for area security, etc. Further, a selected navigation accessory of the plurality of navigation accessories 44 can be mounted onto a corresponding shelf of the plurality of shelves 9 using one or more rail connectors. Alternatively, another selected navigation accessory of the plurality of navigation accessories 44 can be mounted onto a corresponding support rail of the plurality of support rails 2 using one or more rail connectors. In other words, any navigation accessory can be mounted around the structural frame 1 to facilitate the operation of the desired navigation accessory. In other embodiments, different navigation accessories can be removably attached to the structural frame 1 to enhance the autonomous navigation of the system of the present invention.

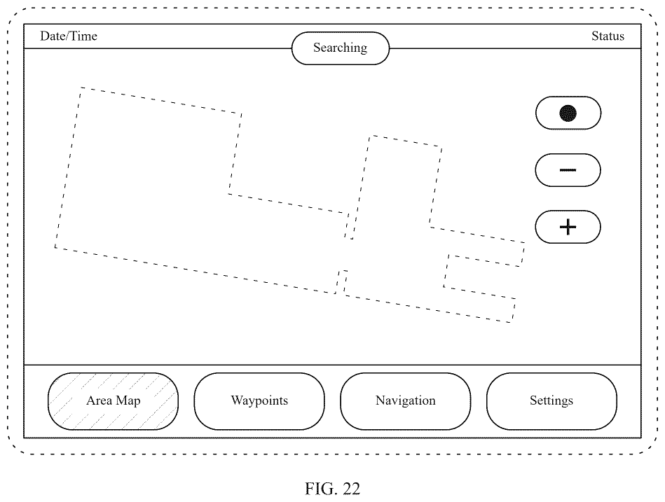

As previously discussed, the present invention can implement a methodology that facilitates the autonomous navigation of the motorized cart. As can be seen in FIG. 22, a virtual map of the operational environment of the motorized cart is stored on the controller 18. The virtual map corresponds to a digital rendition of the physical operational environment of the motorized cart. The virtual map can be manually uploaded into the controller 18 from an external computing system or automatically generated by the autonomous navigation software of the controller 18. In addition, the virtual map can be automatically updated as the motorized cart autonomously navigates through the operational environment. The virtual map includes a database of waypoints, wherein each waypoint corresponds to a specific physical location in the physical operational environment.

In general, the overall process of the method of the present invention includes the steps of prompting the user to input a navigation command using the user interface 39. The navigation command can include information regarding at least one waypoint which the motorized cart must autonomously navigate to. Once the navigation command has been input, the navigation command is relayed from the user interface 39 to the controller 18 from processing. The controller 18 processes the navigational command and generates the appropriate command signals for the pair of motorized wheels 26 to propel the motorized cart towards the corresponding waypoint. As the motorized cart is propelled towards the waypoint by the pair of motorized wheels 26, the plurality of navigational sensors 19 and other navigational devices generate the corresponding sensors signals that help the motorized cart to safely and efficiently navigate through the operational environment towards the target waypoint. The sensor signals are relayed from the corresponding navigational sensor to the controller 18 for processing, and the appropriate feedback command signals are relayed to the pair of motorized wheels 26. For example, if an obstacle is detected in proximity to the motorized cart, the controller 18 can direct the pair of motorized wheels 26 to brake and/or turn the motorized cart to avoid the obstacle. Once the motorized cart arrives at the target waypoint, the user can input a new navigation command towards a new waypoint.

In the preferred embodiment, some navigational sensors of the plurality of navigational sensors 19 are arranged to monitor the surroundings of the motorized cart to prevent collisions while the motorized cart autonomously travels through the operational environment. The subprocess of monitoring the proximity of the motorized cart with the navigational sensors includes the steps of monitoring the motorized cart's surroundings with the plurality of upper TOF sensors 20, the plurality of lower TOF sensors 21, the LiDAR sensor 23, and the image capturing device 38. The plurality of upper TOF sensors 20 preferably monitors elevated obstacles that limits upper clearance of the motorized cart. For example, the plurality of upper TOF sensors 20 prevents the motorized cart from hitting a desk or elevated cabinets. The plurality of lower TOF sensors 21 preferably monitors ground obstacles that limits lower clearance of the motorized cart. For example, the plurality of lower TOF sensors 21 prevents the motorized cart from hitting ground steps or small objects on the ground. Further, the LiDAR preferably monitors objects present around the motorized cart that are at the same level as the motorized cart, such as chairs, other people, etc. Furthermore, the image capturing device 38 captures image data of objects present on the front of the motorized cart that helps the autonomous navigation software determine what the objects are.

Once one or more proximal objects are determined to be present within close proximity of the motorized cart, the controller 18 determines potential obstacles from the proximal objects that may affect the current navigational path of the motorized cart. If one or more proximal objects are determined to be potential obstacles for the current navigational path, the controller 18 generates command signals for the pair of motorized wheels 26 to avoid the potential obstacles. For example, the command signals can include signals for the pair of motorized wheels 26 to decelerate to a stop before colliding with the potential obstacles, turning to avoid the potential obstacles, stopping and backing up to follow a new path, etc. Finally, the generated command signals are transmitted to the pair of motorized wheels 26 which are then promptly executed by the pair of motorized wheels 26. This overall process is iterated for a plurality of iterations at predetermined intervals throughout the autonomous navigation of the motorized cart.

In addition to the autonomous navigation of the motorized cart, the method of the present invention allows for autonomous mapping of the virtual map while the motorized cart autonomously navigates to the target waypoint within the operational environment. To do so, the controller 18 may further include an autonomous mapping software that automatically maps and updates the virtual map as the motorized cart moves through the operational environment. The subprocess of mapping the virtual map while autonomously navigating through operational environment includes the steps of monitoring the motorized cart's surroundings with the plurality of upper TOF sensors 20, the plurality of lower TOF sensors 21, the LiDAR sensor 23, and the image capturing device 38. As the motorized cart moves through the operational environment, the autonomous mapping software tracks objects close to the motorized cart within the operational environment. Once one or more proximal objects are detected near the motorized cart, the proximal object data is relayed to the controller 18 to be processed by the autonomous mapping software. For example, proximal object data can include the current position of the motorized cart, position and distance of the proximal object in relation to the motorized cart, etc. Further, if the detected proximal object exists in the virtual map, the object data is validated by the autonomous mapping software to ensure that stored object data coincides with the collected data. If the detected proximal objects does not exist in the virtual map, the object data is stored and appended into the virtual map so that the virtual map is always up to date.

In addition to maintaining the virtual map updated, the autonomous mapping of the virtual map can help the system of the present invention to determine the current position of the motorized cart in the operational environment. The subprocess of determining the current position of the motorized cart based on proximal objects includes the steps of monitoring the motorized cart's surroundings with the plurality of upper TOF sensors 20, the plurality of lower TOF sensors 21, the LiDAR sensor 23, and the image capturing device 38. With the collected data of the proximal objects around the motorized cart, the autonomous navigational software processes the proximal object data to determine the proximal objects around the motorized cart and the arrangement of the proximal objects relative to the motorized cart. This is then compared with object data currently stored in the virtual by the autonomous navigational software to determine the accurate current position of the motorized cart in the operational environment. In other embodiments, different mapping and navigational methodologies can be implemented to facilitate the autonomous navigation of the motorized cart.

As previously discussed, the system of the present invention enables the manual mapping of the plurality of waypoints of the virtual map corresponding to different physical locations in the operational environment. The subprocess of manually mapping the waypoints of the virtual map includes the steps of moving the motorized cart to the target location in the operational environment. The user can move the motorized cart using the at least one handlebar 42. Once the motorized cart is positioned at the desired location, the user is prompted to designate the current physical location in the operational environment as a waypoint of the virtual map using the user interface 39. The user interface 39 can display a graphical list of available waypoints showing the place holders for unused waypoints. In addition, the user interface 39 can display a graphical dialog to help the user manually designate a physical location as a waypoint. Once the user confirms a physical location in the operational environment as a new waypoint, the physical location data corresponding to the new waypoint is relayed to the controller 18 for processing. Then, the autonomous mapping software appends the new waypoint into the virtual map for future navigation of the motorized cart. Furthermore, the user interface 39 can allow the user to custom label the different waypoints for easier use of the system of the present invention. In other embodiments, different means of creating new waypoints can be implemented.

Although the invention has been explained in relation to its preferred embodiment, it is to be understood that many other possible modifications and variations can be made without departing from the spirit and scope of the invention.

What is claimed is:

1. A system for facilitating the autonomous navigation of a utility and delivery cart comprising:
a structural frame;
a controller;
a plurality of navigational sensors;
a portable power source;
a pair of caster wheels;
a pair of motorized wheels;
the structural frame comprising a plurality of support rails, and a plurality of shelves;
the plurality of shelves being positioned parallel and offset to each other;
the plurality of support rails being positioned parallel to each other;
the plurality of support rails being perimetrically distributed about each of the plurality of shelves;
each of the plurality of support rails being laterally connected to each of the plurality of shelves;
the pair of caster wheels and the pair of motorized wheels being perimetrically distributed about a base shelf of the plurality of shelves;
the pair of motorized wheels being mounted onto the base shelf of the plurality of shelves;
the pair of caster wheels being mounted onto the base shelf of the plurality of shelves, opposite to the pair of motorized wheels;
the plurality of navigational sensors being distributed throughout the structural frame;
the pair of motorized wheels and the plurality of navigational sensors being electronically connected to the controller; and
the pair of motorized wheels, the plurality of navigational sensors, and the controller being electrically connected to the portable power source.

2. The system as claimed in claim 1 further comprising:
the plurality of support rails comprising a first front rail, a second front rail, a first rear rail, and a second rear rail;
the plurality of shelves each comprising a shelf panel;
the first front rail, the second front rail, the first rear rail, and the second rear rail being positioned parallel to each other;
the first front rail, the second front rail, the first rear rail, and the second rear rail being oriented perpendicular to the shelf panel of each of the plurality of shelves;
the first front rail being positioned opposite to the second front rail across each shelf panel of the plurality of shelves;
the first rear rail being positioned opposite to the second rear rail across each shelf panel of the plurality of shelves;
the first front rail being positioned opposite to the first rear rail across each shelf panel of the plurality of shelves; and
the second front rail being positioned opposite to the second rear rail across each shelf panel of the plurality of shelves.

3. The system as claimed in claim 2 further comprising:
a plurality of rail connectors;
the plurality of shelves each further comprising a first lengthwise rail, a second lengthwise rail, a first widthwise rail, and a second widthwise rail;
the first widthwise rail being terminally connected in between the first front rail and the second front rail by a pair of rail connectors of the plurality of rail connectors;
the second widthwise rail being terminally connected in between the first rear rail and the second rear rail by a pair of rail connectors of the plurality of rail connectors;
the first lengthwise rail being terminally connected in between the first front rail and the first rear rail by a pair of rail connectors of the plurality of rail connectors; and
the second lengthwise rail being terminally connected in between the second front rail and the second rear rail by a pair of rail connectors of the plurality of rail connectors.

4. The system as claimed in claim 3, wherein the first front rail, the second front rail, the first rear rail, the second rear rail, the first lengthwise rail, the second lengthwise rail, the first widthwise rail, and the second widthwise rail are slotted metal extrusions, and wherein the plurality of rail connectors is a plurality of slot connectors.

5. The system as claimed in claim 3 further comprising:
the pair of motorized wheels being positioned adjacent to the first widthwise rail of the base shelf of the plurality of shelves; and
the pair of caster wheels being positioned adjacent to the second widthwise rail of the base shelf of the plurality of shelves.

6. The system as claimed in claim 1 further comprising:
the plurality of support rails each comprising a first rail end and a second rail end;
the first rail end being positioned opposite to the second rail end along the corresponding support rail of the plurality of support rails;
the base shelf of the plurality of shelves being positioned adjacent to each second rail end of the plurality of support rails; and
the pair of motorized wheels and the pair of caster wheels being positioned opposite to each first rail end of the plurality of support rails across the base shelf of the plurality of shelves.

7. The system as claimed in claim 6 further comprising:
the plurality of navigational sensors comprising a plurality of upper time-of-flight (TOF) sensors and a plurality of lower TOF sensors;
each of the plurality of upper TOF sensors being mounted onto a corresponding first rail end of the plurality of support rails; and
each of the plurality of lower TOF sensors being mounted onto a corresponding second rail end of the plurality of support rails.

8. The system as claimed in claim 1 further comprising:
an electronics housing;
the controller and the portable power source being mounted within the electronics housing; and
the electronics housing being mounted onto the base shelf of the plurality of shelves.

9. The system as claimed in claim 8 further comprising:
a power switch;
a charging port;
at least one data port;
the power switch, the charging port, and the at least one data port being distributed about the electronics housing;
the power switch, the charging port, and the at least one data port being integrated into the electronics housing;
the power switch and the at least one data port being electronically connected to the controller; and
the power switch and the charging port being electrically connected to the portable power source.

10. The system as claimed in claim 8 further comprising:
an inertial measurement unit (IMU);
the plurality of navigational sensors comprising at least one environmental sensor;
the IMU and the at least one environmental sensor being mounted within the electronics housing;
the IMU and the at least one environmental sensor being electronically connected to the controller; and
the IMU and the at least one environmental sensor being electrically connected to the portable power source.

11. The system as claimed in claim 8 further comprising:
a wireless module;
the wireless module being mounted within the electronics housing;
the wireless module being electronically connected to the controller; and
the wireless module being electrically connected to the portable power source.

12. The system as claimed in claim 1 further comprising:
the plurality of navigational sensors comprising a light detection and ranging (LiDAR) sensor; and
the LiDAR sensor being mounted onto an intermediate shelf of the plurality of shelves.

13. The system as claimed in claim 1 further comprising:
an image capturing device;
the image capturing device being perimetrically positioned about an upper shelf of the plurality of shelves;
the image capturing device being mounted onto the upper shelf of the plurality of shelves;
the image capturing device being electronically connected to the controller; and
the image capturing device being electrically connected to the portable power source.

14. The system as claimed in claim 1 further comprising:
a user interface;
an interface holder;
the interface holder being perimetrically positioned about an upper shelf of the plurality of shelves;
the user interface being laterally mounted onto the upper shelf of the plurality of shelves by the interface holder;
the user interface being electronically connected to the controller; and
the user interface being electrically connected to the portable power source.

15. The system as claimed in claim 1 further comprising:
a plurality of light indicators;
the plurality of light indicators being perimetrically distributed about an upper shelf of the plurality of shelves;
the plurality of light indicators being laterally mounted onto the upper shelf of the plurality of shelves;
the plurality of light indicators being electronically connected to the controller; and
the plurality of light indicators being electrically connected to the portable power source.

16. The system as claimed in claim 1 further comprising:
at least one handlebar;
the at least one handlebar being perimetrically positioned about an upper shelf of the plurality of shelves; and
the at least one handlebar being laterally mounted onto the upper shelf of the plurality of shelves.

17. The system as claimed in claim 1 further comprising:
a plurality of utility trays; and
each utility tray of the plurality of utility trays being situated upon a corresponding shelf of the plurality of shelves.

18. The system as claimed in claim 1 further comprising:
the pair of motorized wheels each comprising a wheel hub, a drive wheel, an electric motor, and an electric brake;
the wheel hub being mounted onto the base shelf of the plurality of shelves;
the drive wheel being rotatably connected to the wheel hub;
the electric motor and the electric brake being mounted within the wheel hub; and
the electric motor and the electric brake being operatively connected to the drive wheel, wherein the electric motor is used to accelerate the rotation of the drive wheel, and wherein the electric brake is used to decelerate the rotation of the drive wheel.

19. The system as claimed in claim 1 further comprising:
a plurality of navigation accessories; and
a selected navigation accessory of the plurality of navigation accessories being mounted onto a corresponding shelf of the plurality of shelves.

20. The system as claimed in claim 1 further comprising:
a plurality of navigation accessories; and
a selected navigation accessory of the plurality of navigation accessories being mounted onto a corresponding support rail of the plurality of support rails.
